(19) United States
(12) Patent Application Publication
(10) Pub. No.: US 2002/0159870 A1
(43) Pub. Date: Oct. 31, 2002

(54) Automated loader arm

(75) Inventors: Claudiu D. Pruteanu, Claremont, MN (US); Gregory P. Dantzman, Owatonna, MN (US); Ronald E. Christenson, Parsons, TN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN

(21) Appl. No.: 09/844,843

(22) Filed: Apr. 27, 2001

(51) Int. Cl. B65F 3/02

(52) U.S. Cl. 414/408

(57) ABSTRACT

A container handling system is disclosed, including subsystems for accessing, grabbing, lifting and tipping collection containers into the charging compartment of a collection vehicle, or the like, and thereafter returning emptied containers to their pick up locations. The invention includes an automated, short radius pivot arm capable of operation in close quarters which may further be mounted to and operated by means of a hydraulic rotary actuator. Electronic control is also provided.

### BACKGROUND OF THE INVENTION

I. Field of the Invention

The present invention relates generally to container handling equipment, including systems for accessing, grabbing, lifting and tipping collection containers into charging compartments of collection vehicles, or the like, and thereafter returning emptied containers to their pick up locations. More particularly, the present invention relates to an automated, short radius pivot arm system and container grabbing device in which the grabbing device is offset and connected to a making the handler capable of operation in close quarters. The pivot arm system may further be mounted to and operated by means of a hydraulic rotary actuator instead of conventional linear actuators.

II. Related Art

Various vehicles dedicated to the collection of refuse or recyclables have included mechanized material handling devices that allow the operator to grab, lift and empty a container of interest without getting out of the collection vehicle. The holding or grasping device is generally connected to an arm or extensible boom which is connected in turn to a base mounted on the vehicle. The arm or boom and grasping device are operated in concert to engage the container of interest lift and dump the container into a receiving hopper in the vehicle.

One such extensible boom device of the class is illustrated and described in U.S. Pat. No. 5,657,654 to Christenson and assigned to the same assignee as the present invention. That reference illustrates a laterally extensible cylinder-operated boom device mounted on a side loading refuse collection vehicle and carrying a tilting bin handler as the container tipping mechanism. Of course, other container manipulating devices may be used in conjunction with such an extensible boom, including conventional grabbing devices which converge around the girth of containers. These grabbing devices are generally attached to arm members configured to pivot in a generally vertical plane to lift and invert a captured container and return it empty to an upright position. One such container grabbing device is illustrated and described in U.S. Pat. No. 5,769,592 to Christenson and also assigned to the same assignee as the present invention. These two cited patents are deemed incorporated herein by reference for any purpose.

Such systems are typically operated using one or more linear operators in the form of hydraulic cylinders to extend and retract the boom, pivot the arm and open and close the grabbing device. The pivot arms of such devices generally cause the container to swing outward and upward in a relatively wide arc before reaching a tipping position to empty the container. After emptying, the cycle is reversed to replace the container at or near its original position prior to emptying.

Thus, these devices normally have a large number of moving parts and bearing surfaces which are exposed to the conditions of refuse collection, or the like, and, as such, tend to require a great deal of maintenance. It would thus be advantageous to provide a simplified mechanism to automatically operate the lift and dump arm function that reduces wear and mechanism complexity. There is also a need to reduce the dumping radius of the lift arm so that the associated collection vehicle can successfully operate in narrower accesses such as alleyways or the like, in addition to emptying curb-side containers on wider streets.

### SUMMARY OF THE INVENTION

The present invention provides an improved container emptying system which includes an offset, short radius lift and dump arm mechanism using a curved arm configuration that may be offset mounted from a laterally extensible boom device to give the system the desired lateral range in accessing containers of interest. The lift and dump arm device may further be mounted from and operated by a hydraulic rotary actuator in a manner that eliminates bearing cylinders and other moving parts associated with arm operation. Any desired type of boom and grabber device compatible with the offset lift and dump pivot arm may be employed to access, capture and hold the container during the emptying operation. Additional details of such devices may be found in the above-incorporated patent documents. The offset mounted arm is provided with a curvature to further reduce the tipping radius and reduce tipping height to facilitate addressing the low hopper opening of a manual sideloading refuse vehicle or the like.

In one embodiment, a grabber assembly is mounted from the free ends of spaced parallel arm members, the fixed ends being connected to the opposite output ends of a double-ended hydraulic rotary actuator which directly carries the arm assembly and reversibly rotates the assembly in a vertical plane. The hydraulic rotary actuator device is mounted on top of an extensible boom lateral reaching device allowing the system to pick up containers at a distance laterally or to operate in a relatively narrow space with the boom fully collapsed or retracted.

In an alternate embodiment, a curved offset automated loader arm is mounted from an offset relatively to an extendible boom and operated utilizing hydraulic cylinders. This system advantageously provides the short lifting and dumping radius in an automated system conventionally driven by hydraulic cylinders.

Another important aspect of the invention is the employment of linear and/or angular displacement transducer devices to provide accurate positional feedback information to a microprocessor controller with respect to boom and arm positions to enable direct and accurate electronic control of the automated operation. This includes the programming of speed with respect to system operation and the determination and notation of location, including pick up location of containers, with respect to replacement of the containers at the desired spot in the operation of the system. In this manner, for example, the rotation of speed and arc length of the lift and dump arm can be precisely controlled based on information provided by an angular transducer in association with the rotation of the associated hydraulic rotary actuator or other rotating shaft. Linear position of hydraulic-operating cylinders can be accurately measured by linear displacement transducers or angular displacement transducers using an associated rotating shaft in a known manner which transmit boom position or, in addition, angular position information for cylinder-operated arms. In this manner, the automation of any arm can be precisely programmed thereby eliminating the need for internal or external cylinder cushioning to dampen the end of strokes or other mechanical devices required to protect the equipment and the containers being manipulated by the equipment.

These and other features and advantages of the present invention will become readily apparent to those skilled in the art from a review of the following detailed description, taken in conjunction with the accompanying drawings and appended claims.

### BRIEF DESCRIPTION OF THE DRAWINGS

In the drawings, wherein like numerals are utilized to depict like parts throughout the same:

FIG. 1 is a side view of a side loading refuse truck showing a side loading refuse hopper equipped with a container handling system in accordance with a cylinder operated embodiment of the present invention;

FIG. 2 is a view of a refuse truck similar to that of FIG. 1 but equipped with a container handling system in accordance with another embodiment of the present invention utilizing a hydraulic rotary actuator;

FIG. 3 is a greatly enlarged side view of the container handling system of FIG. 2 showing the automated loader arm in plurality of positions;

FIG. 4 is a greatly enlarged view showing the attachment of one arm segment of the container handling system of FIG. 2 one of a hydraulic rotary actuator and depicting an attached angular displacement transducer;

FIG. 5 is an enlarged side view of the container handling system of FIG. 1 showing the automated loader arm in two positions; and

FIG. 6 is a greatly enlarged view of a portion of the mechanism of FIG. 5.

### DETAILED DESCRIPTION

The container handling system of the present invention represents advances in the mechanical simplification of rotor arms for container lift and dump mechanisms and by introducing direct pivoting control utilizing a hydraulic rotary actuator. In addition, the invention addresses shortening the radius and thus the area necessary to perform a lift and dump action particularly so that a vehicle utilizing the system may operate within the confines of a narrow access such as an alley and also so that the container can be unloaded at a relatively low level to access the available opening in the normal manual side loading charging hopper. In addition, the system includes positional measurement devices which enable total electronic control of the mechanism with respect to the operations performed, the use of displacement transducer devices in conjunction with microprocessor control enables repeatable precise positioning of containers and lift and dump strokes which are far easier on the loading equipment as well as the containers being emptied. The examples of the invention detailed herein are meant to illustrate the concepts of the invention and not to limit the scope in any manner and should be understood with this in mind.

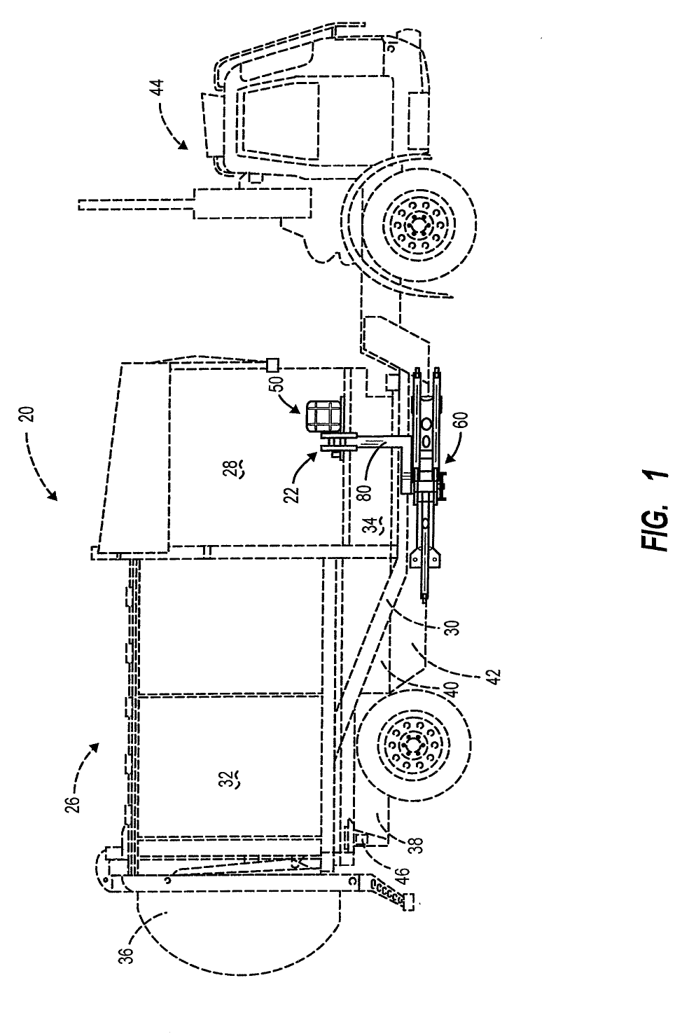

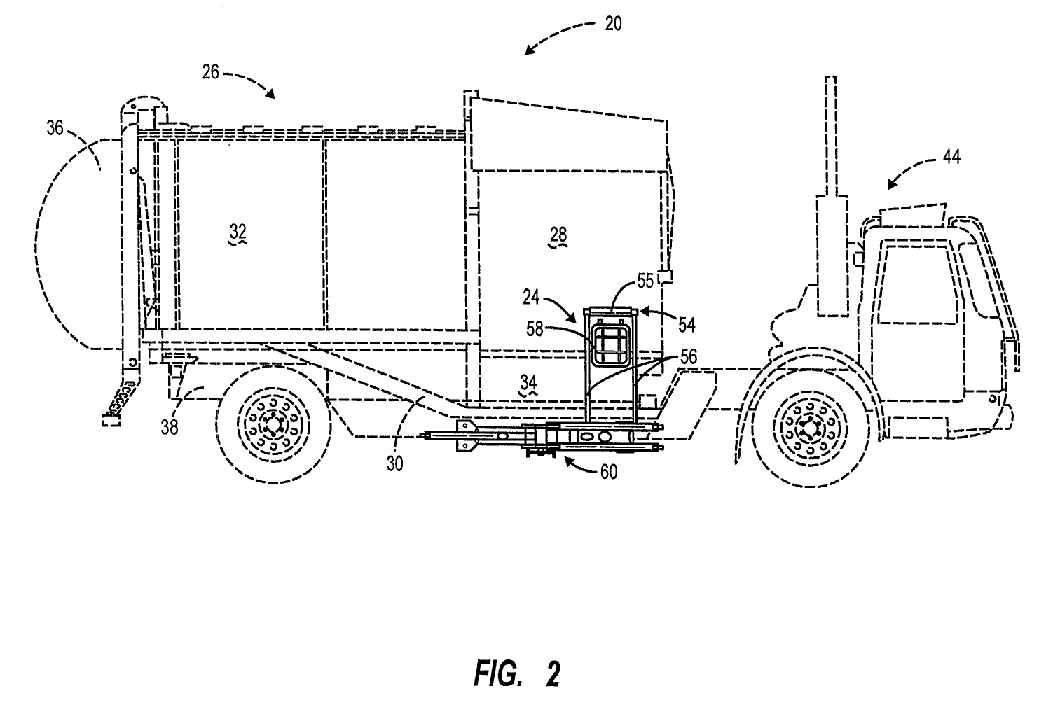

FIGS. 1 and 2 depict a side loading refuse truck generally at 20 which represents one of the several types of such vehicles which make use of container handlers such as that shown in the retracted position 22 in FIGS. 1 and 24 in FIG. 2. Truck 20 is shown as being pivotally attached with the truck body 26 in the lowered refuse collecting or hauling orientation. The illustrated truck body 26 is of a “dropped bottom” variety to accommodate manual side loading and includes a side loading refuse receiving or charging hopper 28 having a lower bottom and side opening to also accommodate manual container dumping attached by an intermediate ramp section 30 which connects to a refuse holding or storage compartment or section 32. Refuse is loaded to in a side opening in the receiving hopper just above the wall 34 and is thereafter push rearward as by a conventional hydraulic cylinder-operated compactor packing ram (not shown) from the hopper bin 28 into the holding or storage body 32 where it is packed against a heavy tailgate 36 as is well known.

The truck body 26 is carried by a heavy truck frame or chassis made up of heavy cross-braced channel members one of which is shown at 38 also provided with transition and lower support members as at 40 and 42. The vehicle is further provided with a cab section 44 situated at the front of the vehicle. The truck body 26 may be of unitary construction in which the receiving hopper 28 and the storage volume 32 are in fact formed together as a single continuous unit. The truck body may further be pivotally attached to the truck chassis or frame as at 46 to enable ejected refuse to be discharged by opening the tailgate 36 and tilting the body 26 as by using a pair of spaced hydraulic lifting cylinders (not shown).

The container handlers 22, 24 may be mounted on the hopper as shown in the figures or optionally mounted on the truck frame or chassis. Both types of mounting are conventional.

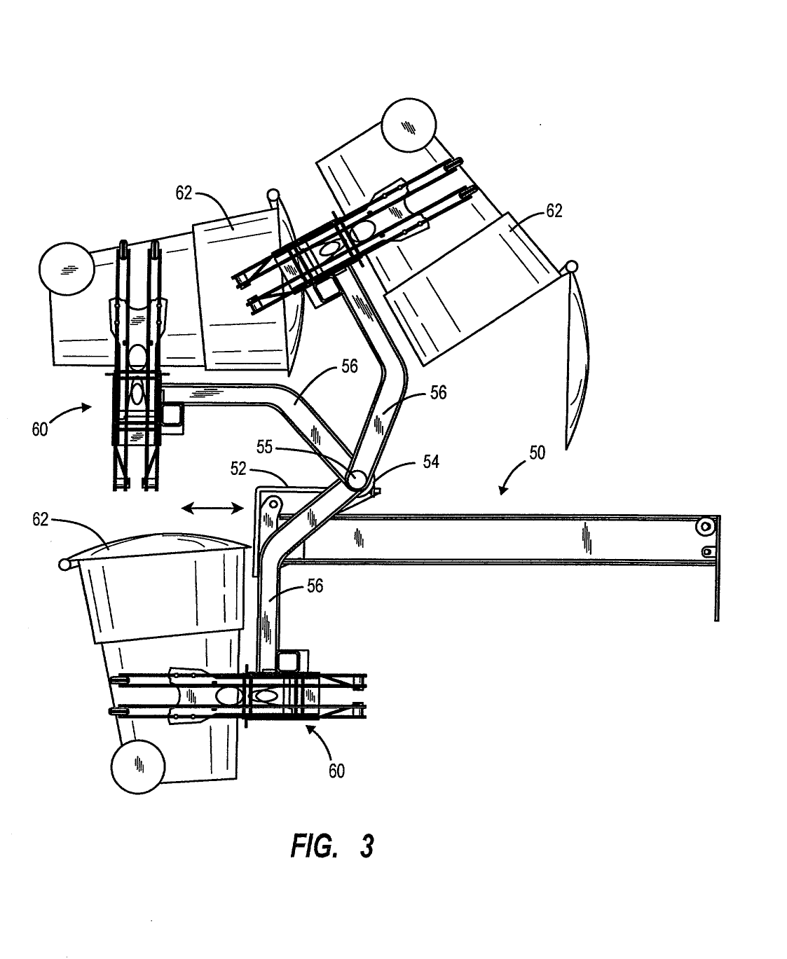

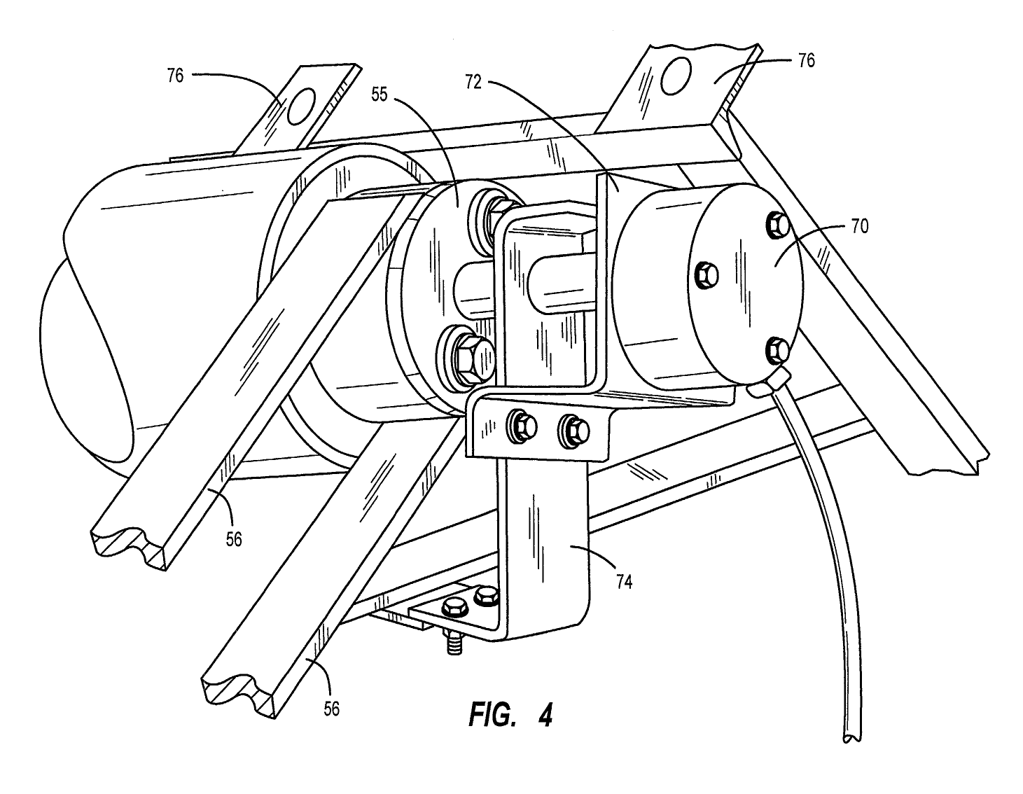

The container handling system of the invention includes an extensible telescoping boom arm indicated generally by the reference numeral 50 attached toward the front of the refuse hopper 28 shown in its fully retracted or collapsed position. The boom 50 generally has an inner section and an outer section which are relatively and longitudinally movable with respect to one another with either the outer or the inner section being a stationary section depending on the design of the system. FIG. 3 depicts a platform 52 mounted on the movable portion of the extensible boom 50 and carrying a hydraulic rotary actuator 54. As seen in FIG. 2, the hydraulic rotary actuator 54 has a double-ended output shaft 55. The actuator 54 carries the mechanized arm arrangement. Each end of the shaft 55 is attached to one of two spaced and cross braced rotary arm members 56 and 58 which carry a gripper mechanism generally at 60 in an offset relation (FIG. 2). Each of the members 56 and 58 is fixed to the output of the hydraulic rotary actuator (as shown in FIG. 4 with respect to the member 56) such that rotation of the hydraulic rotary actuator in either direction causes the spaced arms 56 and 58 of the arm mechanism to rotate in a vertical plane. The gripper 60 may be one such as illustrated in the above-incorporated U.S. Pat. No. 5,769,592 and the extensible boom 50 may be similar to that shown in U.S. Pat. No. 5,651,654 (also incorporated by reference above). A container of interest is illustrated in a plurality of positions is shown at 62. Mechanical stops (not shown) may be provided for the extreme upper and lower positions of the loader arms 56 and 58.

As shown in FIG. 4, the system is provided with an angular displacement transducer as at 70 externally supported on a bracket 72 also fixed to the platform 52 as by a shaped mounting member 74. This transducer which may be a Model 530140 manufactured by Mobil Electronik GmbH of Langenbeutingen, Germany, once calibrated and fixed in position, will translate and transmit data accurately defining the precise relative rotational position of the hydraulic rotary actuator which can be used in the automated controlled operation of the lift arm system. An additional linear displacement transducer device (such as one obtainable from the Hartfiel Company of Eden Prairie, Minn.) may be utilized to provide an accurate reading of the relative extension of the boom 50 so that data coordinating the arm and boom position is always available to a central microprocessor for use in controlling the operation of the system as desired. The system is pictured with the container 62 in the upright, horizontal and tipped positions in FIG. 3.

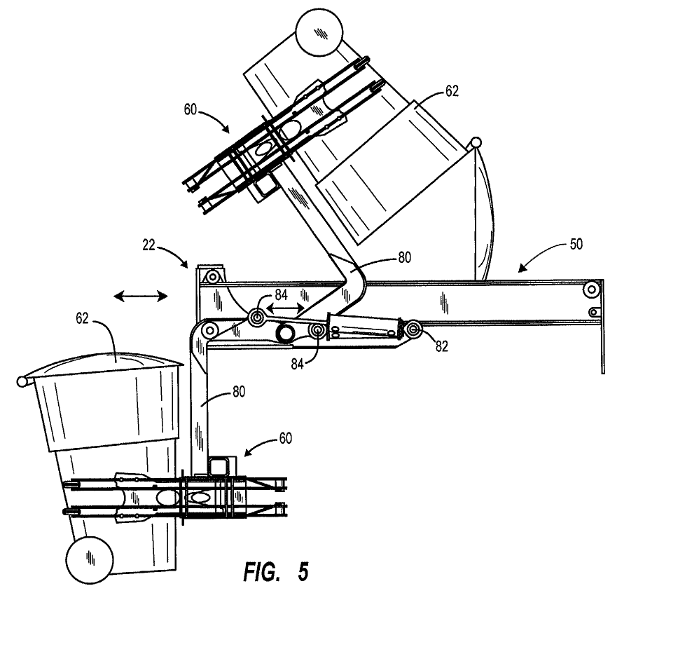

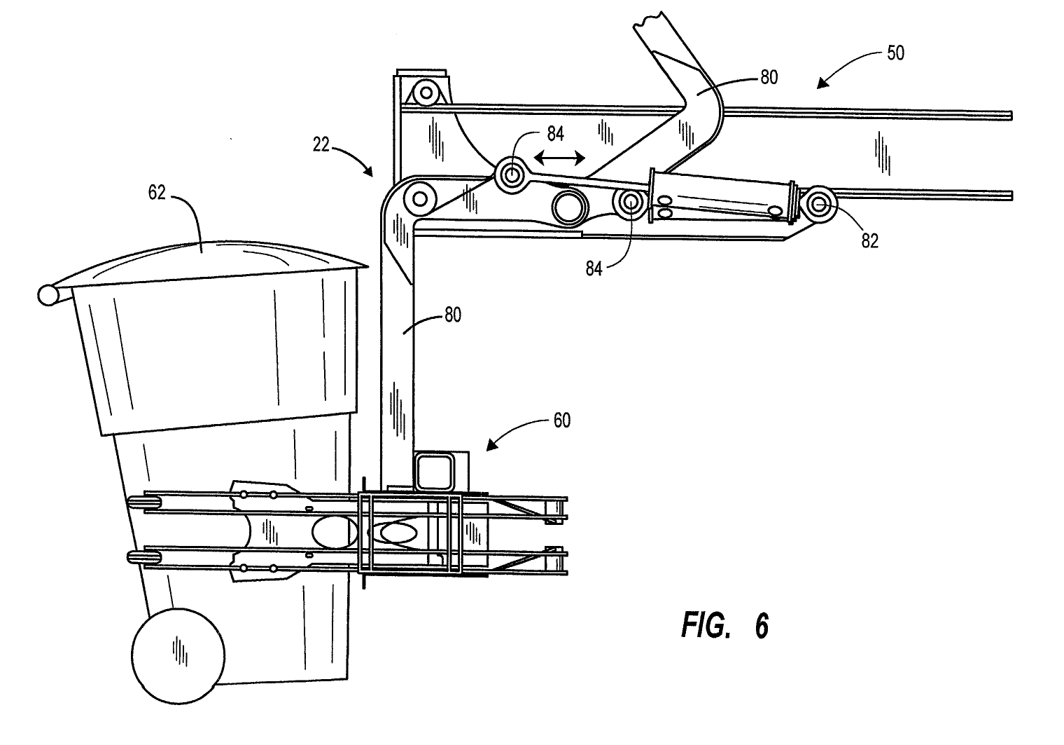

FIGS. 5 and 6 depict an alternate mechanical embodiment of the automated loader arm of the invention in which arm system operation is accomplished by the use of hydraulic cylinder components. As seen in FIG. 1, a single automated loader arm member 80 is connected at a fixed end in a side mount arrangement with an extensible boom 50 and carries a conventional container gripper mechanism 60 in an offset manner at its free end. In FIG. 5, this system is depicted in two positions with respect to a grabbed container 62. In this respect, a hydraulic cylinder anchored at 82 is shown connected to lift the automated loader arm 80 at 84, it being noted that the cylinder is fully extended in the lowered position and retracted with the system shown in the position with the container 62 fully tipped. Other cylinders (not shown) are utilized to operate the boom telescoping system in the directions of the double arrow in a conventional manner. In this embodiment, linear displacement transducer devices (not shown) are also utilized to depict the position of the arm-operating hydraulic cylinder rod and also the boom position so that, as was the case in the hydraulic rotary actuator-operated embodiment, the exact position of the system, including the arm gripper and boom is continually known. These linear transducers are also available from the Hartfiel Company in Eden Prairie, Minn. Such devices provide digital outputs usable by microprocessor-controlled, automated operating systems.

In operation, a side-loading refuse vehicle travels along a street or alley with the extensible boom fully retracted and the loading arm in the lowered position with the container grabber 60 in an open position so that the minimum amount of lateral space is consumed by the system and it does not protrude laterally beyond the side of the vehicle. Upon approaching a container of interest to be emptied, the operator of the truck stops the truck abreast of and at a lateral distance from the container and, if necessary, the extensible boom is extended a sufficient amount such that the grabber may engage and grab the container of interest. In this position, the extension of the boom and position of the arm and grabber can be noted by the control system based on the output of linear and/or angular position sensing devices associated with the extensible boom and automated loading arm. This fixes the location of the container to be emptied. Thereafter, an automated lift, dump and return cycle can be initiated by the operator in such a manner that the container is lifted and the boom, if extended, is retracted and the arm thereafter is rotated to invert the container so that the contents are discharged into the receiving or charging hopper of the side loaded refuse vehicle. The container may be jiggled in this position to insure discharge of wedged materials. These steps may then be reversed so that the container is returned to the position noted when it was grabbed. After the container is released, the boom is again retracted and the grabber opened so that the system is in position for the truck to proceed to the next container.

Positive mechanical stops (as at 76 in FIG. 4) are provided for the maximum limits of the operation of the mechanized system, including the maximum extension and full retraction of the boom, and the extremes of the pivoting of the loading arm assembly. As the mechanized components approach the limits, however, the position-sensing devices prompt control signals which can be programmed into operating software in the memory of the microprocessor to slow the operation of the device down to automatically prevent slamming into stops or inadvertently slamming a container into the ground upon return from emptying, or the like as is possible with manual joystick operation. The use of electronic controls based upon accurate electronic positioning information eliminates the need for damping to be built into the mechanical operating system itself, including custom damping for hydraulic cylinders or rotary actuators. The curved loading arm in conjunction with the fully extensible and retractable boom system minimizes the lift and dump radius associated with the automated lift and dump cycle of the invention such that the containers of interest may be unloaded into a side loader charging hopper at a relatively low height and such that side or lateral space requirements in the operation of the system are minimized.

It will be appreciated that the direct mounting of the automated loading or lift and dump arm assembly to the shaft of the hydraulic rotary actuator eliminates the need for associate linear operators, such as hydraulic cylinder clevis pins and bearing shafts on the outside of the system, except for those associated with the grabbing mechanism itself. This reduces the complexity of the system and the associated maintenance, as well. The use of angular and linear transducer devices in conjunction with the operation of the devices adds a degree of inherent control safety and not possible with operator-controlled systems. It also prevents damage thereby increasing system life.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A container handling system comprising:
(a) an extensible boom mounted so as to provide dumping access to a desired point of discharge for unloading a container of interest;
(b) a mechanized arm arrangement carried by said extensible boom and having a free end, said arm arrangement being rotatable in a vertical plane encompassing container-engaging, container-releasing lift and dump positions;
(c) a container grabber device for grabbing and releasing containers of interest carried by the free end of said arm arrangement;
(d) position sensing system for sensing the relative extension of said boom;
(e) position sensing system for sensing the rotational position of said arm arrangement;
(f) actuators for extending and retracting said boom, reversibly rotating said mechanized arm arrangement and operating said container grabber device; and
(g) a control system for controlling the operation of said container handling system.

2. A container handling system as in claim 1 wherein said control system includes a speed controller for controlling the rotational speed of said mechanized arm arrangement based on sensed arm position.

3. A container handling system as in claim 1 wherein said lateral position sensing system includes an angular displacement transducer.

4. A container handling system as in claim 2 wherein said sensing system for sensing the rotational position of said arm includes an angular displacement transducer.

5. A container handling system as in claim 1 wherein said actuator for reversibly rotating said mechanized arm arrangement is a hydraulic rotary actuator.

6. A container handling system as in claim 4 wherein said actuator for reversibly rotating said mechanized arm arrangement is a hydraulic rotary actuator.

7. A container handling system as in claim 1 wherein said lateral position sensing system includes a linear transducer.

8. A container handling system as in claim 5 wherein said mechanized arm arrangement includes a pair of spaced parallel shaped arms attached to opposite ends of an output shaft associated with said hydraulic rotary actuator.

9. A container handling system as in claim 1 wherein said mechanized arm arrangement includes a single shaped arm member operated by a hydraulic cylinder.

10. A container handling system as in claim 1 wherein said control system for controlling the operation of said container handling system includes a programmed microprocessor.

11. A container handling system as in claim 10 wherein said control system includes control means for damping the action of mechanical parts toward the extremes of travel thereof.

12. A container handling system as in claim 6 wherein said control system for controlling the operation of said container handling system includes a programmed microprocessor.

13. A container handling system as in claim 12 wherein said control system includes control means for damping the action of mechanical parts toward the extremes of travel thereof.

14. An automated container handling system for emptying containers of interest into a charging hopper of a side loading refuse vehicle comprising:
(a) a laterally extensible boom device mounted on said vehicle close to a desired loading area;
(b) a mechanized loading arm device having a fixed end carried by said extensible boom device and a free end, said arm device being disposed for rotating in a vertical plane encompassing container-engaging, release, lift and dump positions;
(c) a container grabber device for grabbing and releasing containers of interest carried by the free end of said arm device;
(d) position sensing system for sensing the relative extension of said boom;
(e) position sensing system for sensing the rotational position of said arm device;
(f) actuators for extending and retracting said boom, reversibly rotating said mechanized arm device and operating said container grabber device; and
(g) a control system for controlling the operation of said container handling system.

15. A container handling system as in claim 14 wherein said control system includes a speed controller for controlling the rotational speed of said mechanized arm arrangement based on sensed arm position.

16. A container handling system as in claim 15 wherein said control system includes a speed controller for controlling the rotational speed of said mechanized arm arrangement based on sensed arm position.

17. A container handling system as in claim 14 wherein said lateral position sensing system includes an angular displacement transducer.

18. A container handling system as in claim 14 wherein said actuator for reversibly rotating said mechanized arm arrangement is a hydraulic rotary actuator.

19. A container handling system as in claim 16 wherein said actuator for reversibly rotating said mechanized arm arrangement is a hydraulic rotary actuator.

20. A container handling system as in claim 14 wherein said lateral position sensing system includes a linear transducer.

21. A container handling system as in claim 18 wherein said mechanized arm arrangement includes a pair of spaced parallel shaped arms attached to opposite ends of an output shaft associated with said hydraulic rotary actuator.

22. A container handling system as in claim 14 wherein said mechanized arm arrangement includes a single shaped arm member operated by a hydraulic cylinder.

23. A container handling system as in claim 14 wherein said control system for controlling the operation of said container handling system includes a programmed microprocessor.

24. A container handling system as in claim 23 wherein said control system includes control means for damping the action of mechanical parts toward the extremes of travel thereof.

25. A container handling system as in claim 19 wherein said control system for controlling the operation of said container handling system includes a programmed microprocessor.

26. A container handling system as in claim 25 wherein said control system includes control means for damping the action of mechanical parts toward the extremes of travel thereof.

27. A container handling system comprising:
(a) a mechanized arm arrangement having a fixed end and having a free end, said arm arrangement being rotatable in a vertical plane encompassing container-engaging, container-releasing lift and dump positions;
(b) wherein said fixed end of said arm arrangement is attached to a rotary actuator for carrying and reversibly rotating said mechanized arm arrangement;
(c) a container grabber device for grabbing and releasing containers of interest carried by the free end of said arm arrangement;
(d) actuator for operating said container grabber device; and
(e) a control system for controlling the operation of said container handling system.

28. A container handling system as in claim 27 wherein said control system includes a speed controller for controlling the rotational speed of said mechanized arm arrangement based on sensed arm position.

29. A container handling system as in claim 28 wherein said sensing system for sensing the rotational position of said arm includes an angular displacement transducer.

30. A container handling system as in claim 27 wherein said actuator for reversibly rotating said mechanized arm arrangement is a hydraulic rotary actuator.

31. A container handling system as in claim 28 wherein said mechanized arm arrangement includes a pair of spaced parallel shaped arms attached to opposite ends of an output shaft associated with said hydraulic rotary actuator.

32. A method of operating a container handling system for lifting and dumping a container of interest utilizing a pivoting mechanized arm arrangement carried by an extensible boom, in turn, mounted so as to access a desired point of discharge, for unloading a container of interest, said mechanized arm arrangement carrying a mechanized container grabber at the free end thereof, said method comprising the step of pivoting said mechanized arm arrangement utilizing a hydraulic rotary actuator.

33. A method as in claim 32 further comprising the steps of obtaining positional information relative to boom extension, and the angular position of said mechanized arm arrangement utilizing one or more transducer devices selected from linear and angular displacement transducer devices.

34. A method as in claim 33 further comprising the steps of:
(a) storing in memory the positional extremes of said telescoping boom and mechanized arm arrangements;
(b) comparing the instant positional data with the data relative to said extreme positions; and
(c) electronically causing one or more of said mechanisms to slow when approaching the extreme position thereby preventing the slamming of parts into stops.

35. A method as in claim 27 wherein one of said extreme positions is the noted position of pick up of the then relevant container of interest.
